(19) United States
(12) Patent Application Publication
(10) Pub. No.: US 2009/0000836 A1
(43) Pub. Date: Jan. 1, 2009

(54) Balanced Belt or Chain Drive for Electric Hybrid Vehicle Conversion

(76) Inventor: Paul Harriman Kydd, Lawrenceville, NJ (US)

Correspondence Address: Paul H. Kydd, 32 Woodlane Rd., Lawrenceville, NJ, 08648, US

(21) Appl. No.: 12/163,496

(22) Filed: Jun. 27, 2008

Related U.S. Application Data
(60) Provisional application No. 60/958,082, filed on Jun. 30, 2007.

(51) Int. Cl. B60K 1/00; B60K 6/20

(52) U.S. Cl. 180/65.2; 180/65.6

(57) ABSTRACT

A drive assembly is described which can apply a pure torque to a driven member while allowing for limited motion of the driven member in the radial direction. This drive assembly is particularly suitable for converting an Internal Combustion (IC) vehicle to an IC-electric hybrid vehicle comprising installation of two electric motors coupled to a drive shaft of the vehicle via the drive of this invention such that the electric motors can provide some or all of the mechanical power required to propel the vehicle while accepting some relative motion between the existing vehicle drive shafts and the chassis and imposing minimal radial force on the drive shaft.

### CROSS-REFERENCE TO RELATED APPLICATIONS

This application claims the benefit of U.S. Provisional Patent Application Ser. No. 60/761,231 filed Jan. 23, 2006, embodied in U.S. Patent Application US2007/0169970 A1, filed Jan. 17 2007, the complete disclosure of which is hereby expressly incorporated by reference, as well as Provisional Patent Application Ser. No. 60/900,384 filed Feb. 8, 2007, and Provisional Patent Application 60/958,082 Filed Jun. 30, 2007, all by the present inventor. Specifically this application claims the date of Provisional Patent Application 60/958,082 for the matter disclosed therein.

### FEDERALLY SPONSORED RESEARCH

None

### CITED LITERATURE

Kyle, Ronald L., U.S. Patent Application US2006/0030450 A1, Feb. 9, 2006

Kydd, Paul H. U.S. Patent Application US2007/0169970 A1, Jul. 26, 2007

### BACKGROUND OF THE INVENTION

This invention is broadly applicable to driving a rotating shaft which must be allowed to move radially to accommodate vibration and motion relative to the fixed surroundings. It has particular utility as it relates to a hybrid internal combustion-electric drive system for a vehicle, and specifically to such a drive system that is retrofittable to existing internal combustion engine vehicles. The drive system comprises a flexible speed reduction system that enables one or more standard electric motors to propel the vehicle solely by electric power as a “strong hybrid” as described in U.S. Patent Application US 2007/0169970 A1, Jul. 26, 2007 “Electric Hybrid Vehicle Conversion” by Paul H. Kydd. That application discloses an electric motor mounted on the chassis of a vehicle and driving the drive shaft of the vehicle by a flexible drive means such as a toothed timing belt or a chain. The use of a flexible drive means is essential to accommodate vibration and relative movement of the drive shaft relative to the chassis of the vehicle. A similar system disclosed by Kyle in U.S. Patent Application US2006/0030450 A1, Feb. 9, 2006, describes a rigidly mounted transfer gear box to apply torque to the drive shaft which does not meet this requirement.

The flexible speed reduction subsystem of this present invention is a balanced belt or chain drive mounted to the chassis of the vehicle which applies a pure torque to the driven member, and allows for limited motion in both radial directions to accommodate vibration and relative motion. It can accommodate such motion without imposing significant radial loads on the driven member, and it achieves any degree of belt tensioning necessary without imposing such radial loads.

The application of an electric belt or chain drive to many vehicles is complicated by the fact that the forward universal joint of a single-part drive shaft is relatively inaccessible for the mounting of a drive pulley, and it is supported by a simple bushing at the output end of the transmission shaft extension, which is incapable of sustaining the radial tension required to avoid slippage and skipping in the drive belt or chain. A drive configuration is required which will apply a pure torque to the universal joint while allowing it to move slightly in both radial directions to accommodate the motion of the engine-transmission unit in its flexible mounts. The drive must allow for a significant tensioning force to prevent slipping of the belt or chain without displacing the driven member by application of significant radial force as in a simple belt drive. The same requirement is met with two-piece drive shafts because the center bearing is flexibly mounted to allow for vibration and motion of the two halves of the shaft.

### BRIEF SUMMARY OF THE INVENTION

This invention comprises a balanced belt or chain drive, consisting of a driven pulley or sprocket driven by a toothed timing belt or chain with idler rollers on either side of the driven member such that all the forces on the driven member are balanced except for torque. One or more driving means, preferably two electric motors, engage the belt or chain via drive pulleys or sprockets in such a way that they apply tensioning forces to the belt which offset one another and driving forces which combine with one another to provide torque to the driven member.

This drive may be applied to provide a flexible speed reduction connection to the drive shaft of a conventional internal combustion engine vehicle to permit operation on either internal combustion or electric power or both together. It is an objective of the present invention to provide such a drive enabling the use of the hybrid drive method disclosed in U.S. Patent Application US2006/0030450 A1, Feb. 9, 2006, in vehicles of almost any type having rear-wheel or all-wheel drive.

### BRIEF DESCRIPTION OF THE DRAWINGS

The means by which these objectives are achieved by the present invention are illustrated in the accompanying drawings:

FIG. 1 is a schematic plan view of the major mechanical components of the drive system of this invention applied to a vehicle with a single drive shaft looking upwards from below.

FIG. 2 is a schematic elevation view of the major mechanical components of the invention looking rearwards from the engine-transmission.

FIG. 3 is a schematic plan view of the invention applied to a two-part drive shaft looking upwards from below.

FIG. 4 is a schematic elevation view of the major mechanical elements of the invention with idler rollers to increase the “wrap” of the belt or chain looking rearwards from the transmission.

FIG. 5 is a schematic elevation view of the major mechanical elements of the invention with idler rollers and the electric motors offset to clear a low vehicle framework.

FIG. 6 is a schematic elevation view of the major mechanical elements of the invention employing a single drive motor.

FIG. 7 is a schematic elevation view of the gearbox of FIG. 6 cut away to show the gears and limited slip drive elements.

FIG. 8a. is a schematic elevation of the motor of FIG. 7 with drive pulleys mounted on a single shaft. FIG. 8b. is a schematic plan view of the motor of FIG. 8a. showing interleaved drive belts 24a. and 24b.

### DETAILED DESCRIPTION OF THE INVENTION. THE PREFERRED EMBODIMENT

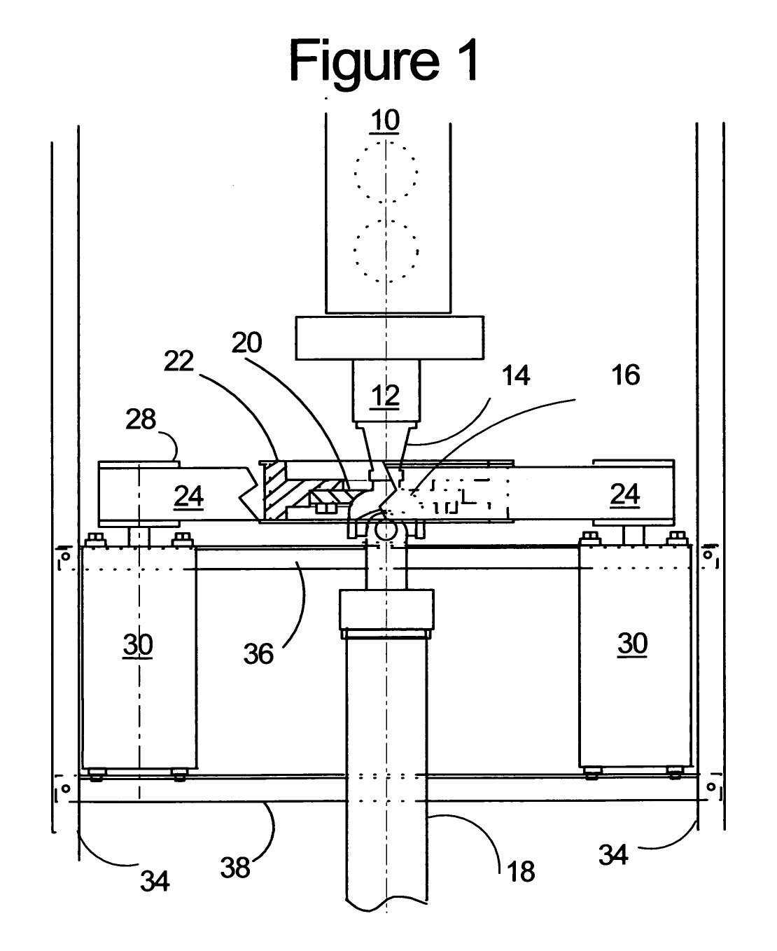

FIG. 1 schematically illustrates the mechanical components of the hybrid drive system of this invention in which an internal combustion engine 10 with transmission 12 has an output shaft extension 14 supporting an internal output shaft (not shown), which is typically coupled to universal joint 16 by a spline joint. Universal joint 16 drives shaft 18 to propel the vehicle.

Added mechanical components of the drive system of this invention include disc 20 welded to the transmission side of universal joint 16, and timing belt pulley or chain sprocket 22 bolted to disc 20. Frame rails of the vehicle 34 support added cross members 36 and 38, which support electric motors 30 having driving pulleys or sprockets 28 which drive pulley or sprocket 22 by means of belt or chain 24.

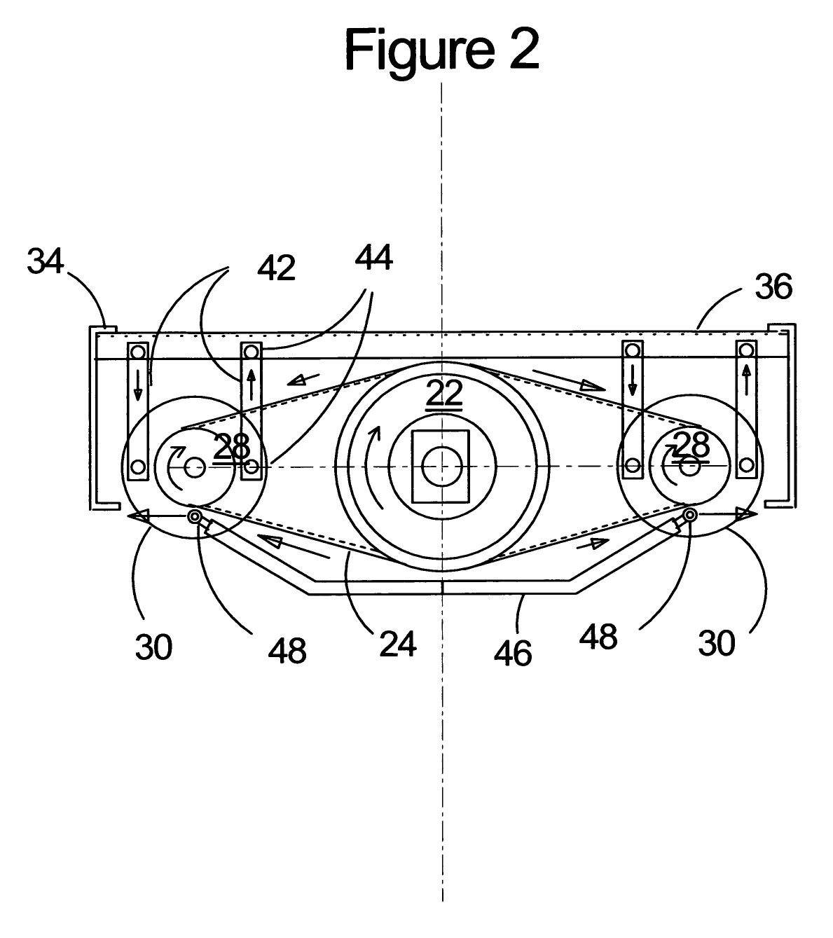

FIG. 2 shows schematically how motors 30 are mounted from cross members 36 and 38 by links 42 and shoulder screws 44 serving as pivot points allowing the motors to swing freely radially to tension the belt or chain while absorbing the rotational reaction torque of the motors and preventing it interfering with the tensioning. Similar links 42 and cross member 38 shown in FIG. 1 support the rear end of the motors swingably while holding the motors in axial alignment with the driven pulley 22. Tensioner rod 46 with adjustable rod ends 48 exerts a force outward to tension the belt or chain 24 and prevent slippage, while providing resilience to prevent over tension and to allow for wear and stretch of the belt 24.

It is an essential feature of this invention that the driven pulley 22 is driven from both sides by a balanced set of forces generated by a continuous belt or chain or two opposed belts or chains. Because the motors are mounted so as to move independently in the radial direction but are restricted from rotating by links 42, the tension in such a belt is the same on both sides of the driven pulley. It is important to note that the loop of belt on each side of driven pulley 22 is constrained such that moving the motor outward to tension the belt will pull the driven pulley sideways without rotating it. To achieve a balance of forces on driven pulley 22 it is necessary that both motors be free to move outwards and that they be driven outwards by the same force, which is most easily achieved by the parallel link mount and single tensioner rod arrangement of the preferred embodiment shown in FIGS. 2,4 and 5. For rotation in the clockwise direction shown in FIG. 2 the forces on the belts, links and motors are as shown by the arrows, which can be seen to be balanced. The torque on pulley 22 is provided by the imbalance between the tension in the upper an lower runs of the belt which is equal but inverted on opposite sides of pulley 22.

FIG. 2 shows that slight relative motion of the center pulley 22 in the vertical direction simply lengthens the upper runs of belt and shortens the lower runs without materially changing the tensions. The length changes are accommodated by a slight difference in relative rotation of the two motors 30. The force required to achieve this displacement is small both statically and dynamically. If the distance between pulleys 22 and 28 is 10 inches, and the displacement is 0.1 inch, for example, the static vertical force is 4T sin 0.01=0.0007T where T is the mean tension in the belt. Dynamically, the moment of inertia of the motor rotors will add to this due to the necessity for a slight differential in rotational speed, but this effect is small relative to the static force.

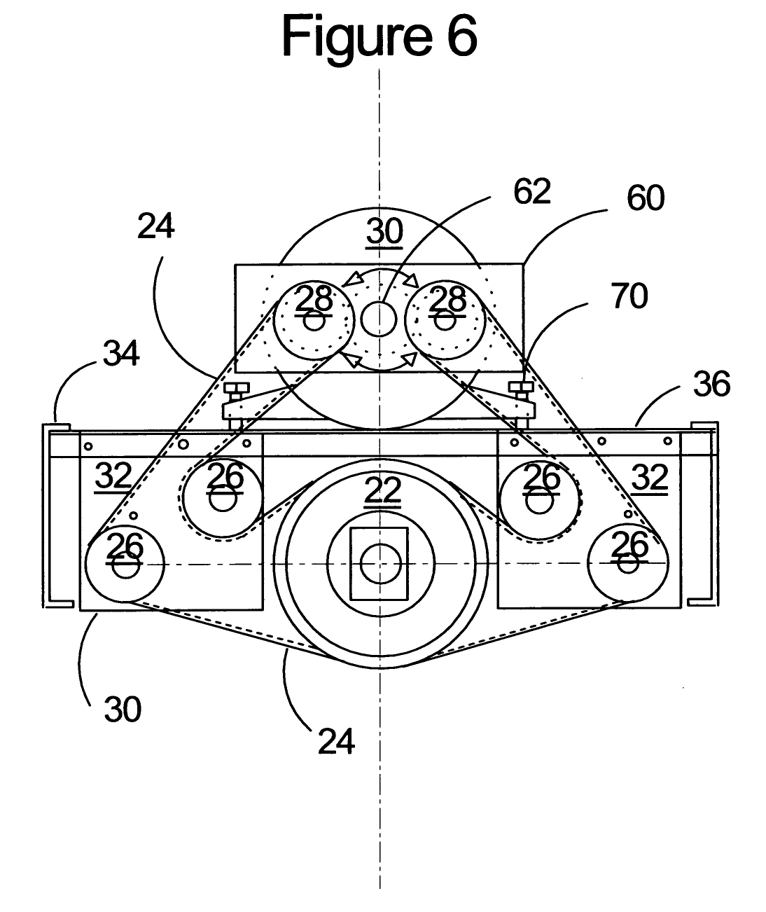

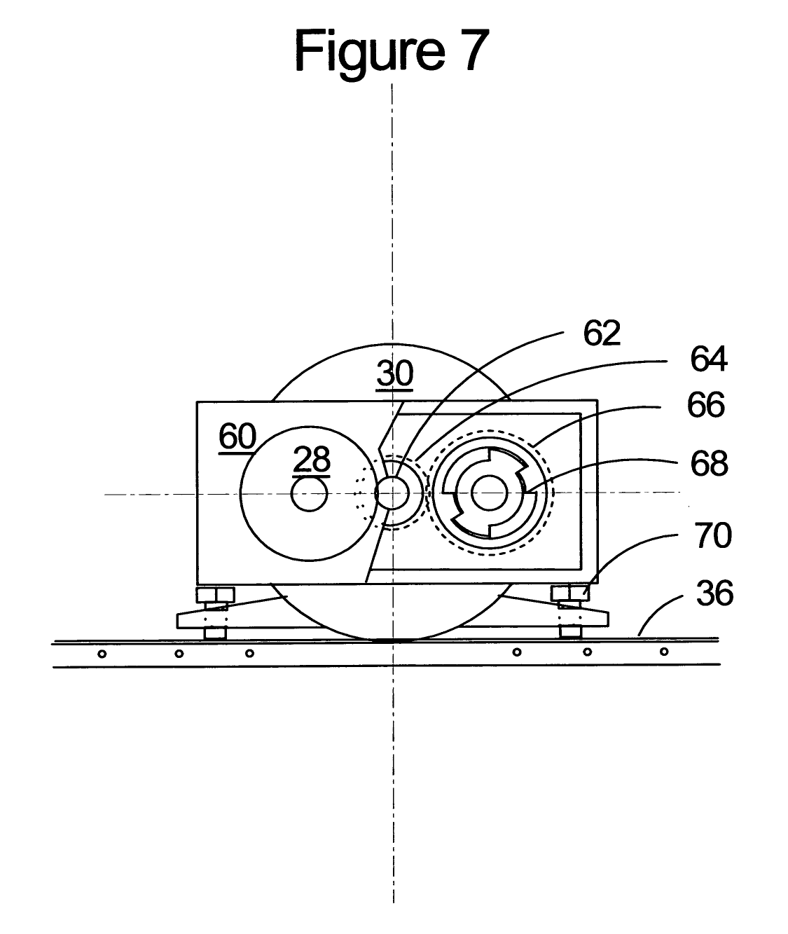

Vibrations of pulley 22 in the horizontal direction are accommodated by both motors 30 moving sidewise on the parallel link mounts 42 while maintaining their relative spacing imposed by tensioner rod 46. Here the static force is imposed only by the gravitational force on the displaced motors, which is negligible. The dynamic resistance to sidewise motion, however, can be large at high vibration frequencies because the entire mass of both motors must be moved sidewise. For small amplitudes, this can be taken up by stretch and slack in the belt, but for large amplitudes of lateral vibration the single motor installation pictured in FIGS. 6 and 7 is preferred.

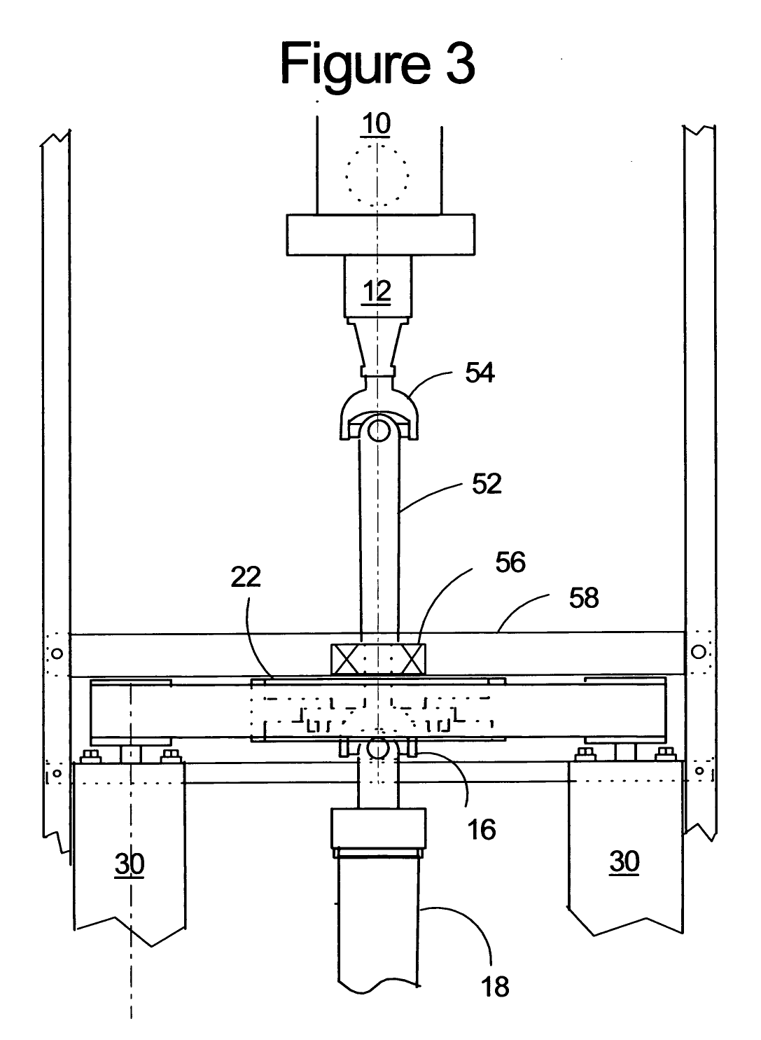

The balanced drive of this invention can equally well be used at the intermediate bearing in a two part drive shaft as used on trucks and SUVs, as shown in FIG. 3. In this case the transmission 12 drives first drive shaft 52 through universal joint 54. First drive shaft 52 is supported by center bearing 56 mounted on cross member 58. The output end of shaft 52 is typically splined to mate with universal joint 16 of second drive shaft 18 to complete the connection to the rear wheels (not shown). All the other components of FIGS. 1 and 2 are substantially the same as described previously. Pulley 22 is attached to universal joint 16 as shown in FIG. 1.

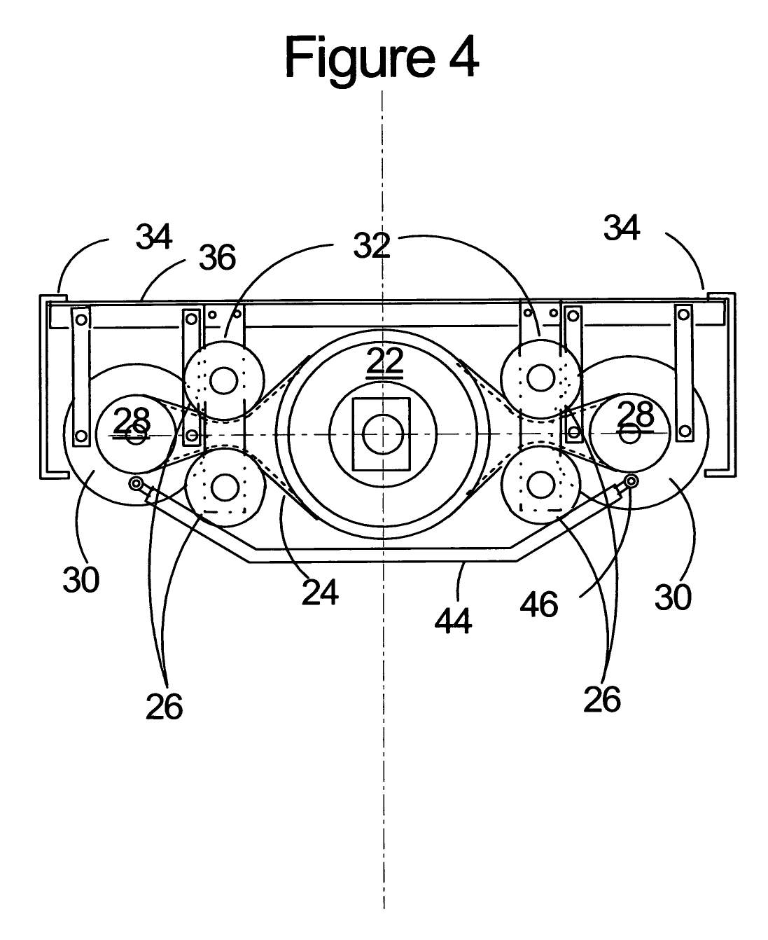

FIG. 4 shows the invention with idler rollers 26 mounted on plates 32 fixed to crossmember 36 to increase the wrap of the belt or chain around sprockets 22 and 28 for greater torque transmission capability.

Electric motors 30 may be either a variable speed AC or DC motor, preferably of adequate power to propel the vehicle at highway speeds, for example the X91 4003 6.7 inch diameter series wound DC motor from Advanced DC Motors, Inc. Syracuse, N.Y. The belt drive of this invention provides speed reduction between the electric motors and the drive shaft of the vehicle to match the motor to the requirements of the vehicle and allow physically smaller motors to provide the requisite torque. Typically the shaft will run at approximately 3000 rpm at a vehicle speed of 65 mph, while the electric motors will run at approximately 6000 rpm.

The flexible speed reducer of this invention may be of any type that provides the desired torque and power capability to match the requirements of the vehicle to electric motors 30. It is shown as a timing belt drive, which is desirable for silent operation in the dirty and wet environment under the vehicle. V belt and J belt drives also are silent and dirt resistant, but provide less torque capability. Chain drives provide still more torque, but are noisy and subject to wear in a dirty environment. The drive can be mostly enclosed in a sheet metal case to muffle the noise and keep out the dirt while allowing relative motion between the drive line and the frame of the vehicle.

The idler pulleys of the preferred embodiment are not essential but will provide maximum torque transmission capability for a given belt or chain by increasing the “wrap” of the belt or chain around the driving and driven pulleys. It is important that the idlers be mounted in axial and radial alignment with the center line of the driven pulley and equally spaced from it radially to achieve balanced forces on the driven pulley.

### Other Embodiments

Motors 30 may be mounted in any position, to the rear of the drive as well as in front, depending on the space available in a particular vehicle, provided that the conditions of alignment, independent outward motion of the motors and equal tensioning, recited above, are met.

Tensioning may be accomplished by a variety of means as long as the means applies and equal force to each motor 30. It is desirable that the tensioning means provide the capability to automatically adjust for wear and stretch of the belt or chain. Suitable tensioning means include a slightly bent tensioning rod as shown in FIGS. 2, 4 and 5, a pneumatic piston and cylinder, a hydraulic piston and cylinder or a spring. The link mounting to allow radial motion while counteracting the reaction torque on motors 30 could be replaced by a mechanical slide mounting.

In some cases it may be desirable to locate the electric motors remotely from the speed reducing connection to the drive shaft and drive the pulleys 28 with long shafts or belts from the motors. For example, the motors may be located in the spare tire well behind the rear axle with shafts extending to the midpoint of the vehicle where the intermediate bearing is located. This also will alleviate the dynamic resistance to sidewise vibration noted above in paragraph 20 by reducing the mass of the drive directly linked to pulley 22.

It may be desirable to interpose a clutch between pulley 22 and universal joint 16, or between drive pulleys 28 and motors 30 to allow the vehicle to run under engine power without wind milling the electric motors.

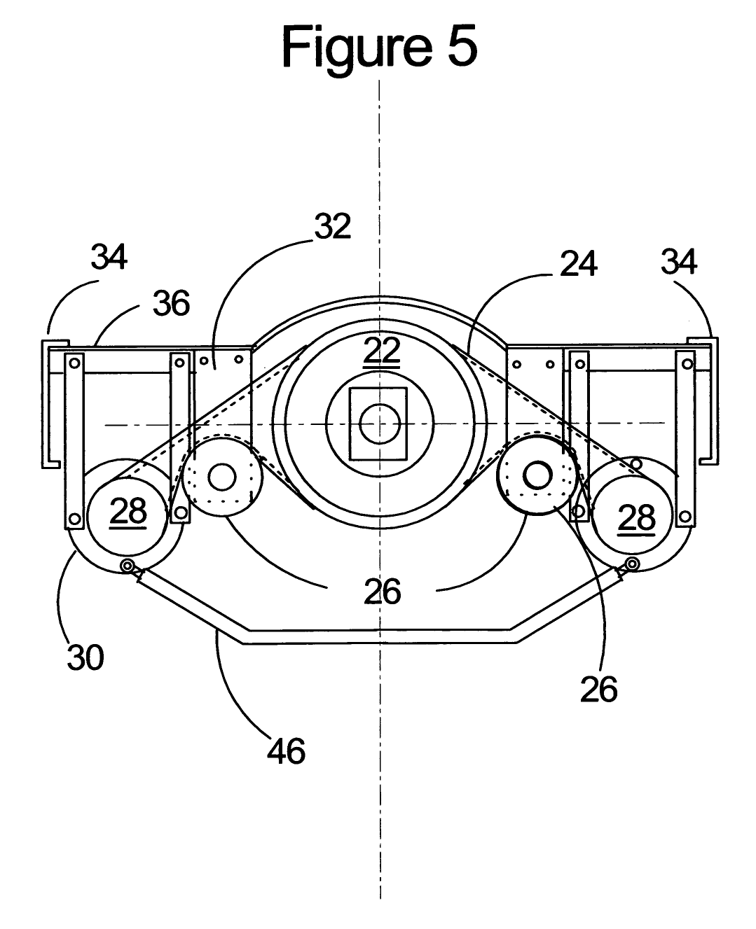

In some vehicles there is inadequate space below the floor to accommodate electric motors 30 on the same plane as pulley 22 which must be centered on the drive shaft. FIG. 5 shows the invention applied to such a case in which motors 30 are mounted below the centerline of pulley 22 by the maximum amount in which the belt would just graze upper idler 26 in FIG. 4. In this case the upper idler can be eliminated. For lesser angles between the motors 30 and horizontal both idlers are necessary, but the forces are still balanced as shown in FIG. 2 as long as the angles made by the four runs of belt 24 are equally disposed around pulley 22.

In many cases it will be advantageous to provide extra torque to a drive shaft with a single motor 30 while maintaining balanced forces on the shaft per the teachings of this invention. To do this it is necessary to drive two pulleys 28 from the single motor 30. It is not adequate to use an idler pulley 28 on one side as an inspection of FIG. 2 will demonstrate. The unbalanced tension in the belt on one side which provides the driving torque uncompensated by unbalanced tension on the other side produces a vertical force on pulley 22 which is unacceptable.

FIG. 6 shows how this may be accomplished. Motor 30 drives pulleys 28 through a gear box 60 which is mounted rotatably on the shaft 62 of motor 30. Pulleys 28 drive pulley 22 via belt or chain 24 and idler rollers 26 which are rigidly mounted on plates 32 and crossmember 36 as before. Additional idlers can be used to achieve greater wrap, provided that the angles of the four runs of belt 24 leading to pulley 22 are equal as described above.

Horizontal vibration of pulley 22 is accommodated by rocking of gearbox 60 around shaft 62 of motor 30 which allows the loops of belt 24 to lengthen on one side and shorten on the other. The static force required to do this is zero and the dynamic fore is much reduced relative to the two motor installation pictured in FIGS. 2, 4 and 5 because only the moment of inertia of the gearbox around shaft 62 resists this rocking motion rather than the entire mass of two motors 30.

Vertical motion of pulley 22 is accommodated as before by slight relative rotation of the two pulleys 28. For this reason these pulleys must each be driven by a flexible or a limited slip connection to motor 30 as shown in FIG. 7, which is a cutaway view of gear box 60. Gear box 60 is mounted on output shaft 62 of motor 30 which also drives central pinion gear 64. Pinion 64 drives output gears 66 which in turn drive pulleys 28 via limited slip or flexible couplings 68 providing some relative rotation between pulleys 28 to allow for vertical vibration of pulley 22. The limited slip means can be a simple mechanical connection as shown or prefereably any one of numerous flexible shaft couplings such as Lovejoy elastomeric jaw type couplings which interpose a rubber spider between the mechanical elements of coupling 68.

Tensioning of the single motor drive is accomplished by raising the motor and gear box together with jack screws 70.

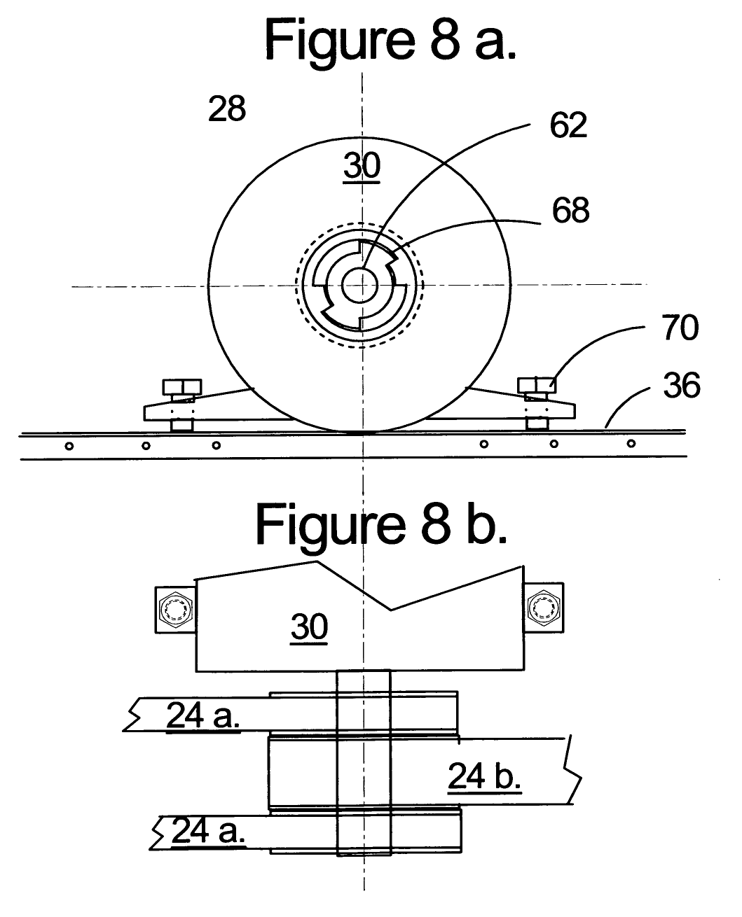

Instead of a single belt or chain two belts or chains may be used, one for each drive pulley 28. This arrangement will achieve better wrap around driven pulley 22. Chain drives are narrow enough that it is not necessary to balance the axial couple produced by two sprockets driving the same shaft but displaced axially enough to clear one another. For timing belt drives which must be at least two inches wide it is desirable to balance the drives by using several belts on the same pulleys as shown in FIG. 8 b.

This multi belt approach allows for simplifying the single motor drive shown in FIGS. 6 and 7 by mounting pulleys 28 directly on the motor shaft 62 with individual flexible couplings 68 allowing for relative rotation of the drive pulleys 28 to accommodate vertical vibration of pulley 22. Mounting motor 30 so that it can rock sidewise will accommodate horizontal vibration in pulley 22, although this refinement may be unnecessary if the vibrations can be accommodated by stretch and slip of the lengthy belts used in a single drive.

### EXAMPLE

A 1986 Chevrolet S-10 with a two part drive shaft was converted to a plug-in hybrid by the teachings of U.S. Patent Application US2007/0169970 A1 using an Advanced DC FB1 9 inch diameter electric motor, a Curtis 1231 controller and ten GNB group 24 12 V batteries charged by a Zivan NG3 charger. The center bearing mount was strengthened to resist the side force and a chain drive was used to transmit torque form the motor to the drive shaft with tolerance for sidewise displacement of the shaft by the tension in the chain. The vehicle could be run satisfactorily up to 35 miles per hour on electric power only, but the chain drive was noisy and the torque had to be limited by the controller to accommodate the sidewise flexing of the stiffened drive shaft mounting.

The vehicle was modified according to the teachings of the present invention by replacement of the single motor by two Advanced DC X91 4003 6.7 inch diameter series wound DC motors driving the shaft via a 2 inch wide ½ inch pitch timing belt with idler rollers as shown in FIG. 4. The center bearing was returned to its original unstiffened state. No evidence of side force on the center bearing was noticeable during operation, and the noise of the drive was substantially reduced. The vehicle performed well on a simulated 25 mile commuting trip over public roads.

I claim:

1. A force-balanced, flexible drive in which a driven member is subjected to a pure torque while allowing limited motion in both radial directions to accommodate vibration and relative motion between the driven shaft and the fixed surroundings by a plurality of driving means which apply forces to the driven member which are automatically balanced except for the torque on the driven member.

2. The drive in claim 1 in which the driven member comprises one or more pulleys or sprockets driven by one or more belts or chains with loops on opposite sides of the driven member, in which each loop is driven by a driving means having a pulley or sprocket which exerts forces on the loop which are equal and opposite to the forces exerted by the opposite driving means, resulting in a pure torque being applied to the driven member.

3. The drive in claim 1 installed in a motor vehicle to provide additional torque on a drive shaft of the motor vehicle enabling its operation as a parallel hybrid vehicle while maintaining limited radial movement of the shaft relative to the chassis of the vehicle without imposing excessive radial loads.

4. The drive in claim 1 in which idler rollers or sprockets fixed to the surroundings are used to obtain additional “wrap” and torque transmitting ability for the belt or chain.

5. The drive in claim 1 in which the belt is chosen from the group: V belt, multigroove J belt, cogged belt and timing belt.

6. The drive in claim 1 in which the chain is chosen from the group: single strand roller chain, multiple strand roller chain and internal tooth silent chain or timing chain.

7. The drive in claim 1 in which the driving means are chosen from the group: DC electric motors, AC electric motors, hydraulic motors, pneumatic (compressed air driven) motors, steam engines and turbines, and internal combustion engines, including reciprocating and turbine engines.

8. The drive in claim 1 in which two equal driving means are employed to drive the two driving pulleys or sprockets, wherein those driving means and pulleys are mounted on link or slide means fixed to the surroundings so as to allow radial motion of the driving means and pulleys relative to the driven member, but not rotational motion due to the reaction torque on the driving means, and the two driving means and pulleys are forced apart by a single tensioning means to produce equal and opposite forces on the driven means except for torque imposed by rotation of the driving means.

9. The drive in claim 1 in which tensioning means to remove slack in the belts or chain loops is chosen from the group: a rod of adjustable length, a hydraulic assembly with one or more pistons driven by hydraulic fluid pressure to apply equal and opposite force to the two drive means, a pneumatic assembly with one or more pistons driven by gas pressure to apply equal and opposite force to the two drive means, or a spring which may act via cable means to apply equal and opposite force to the two drive means.

10. The drive in claim 1 in which the driving means are located remotely and drive the driving pulleys or sprockets via flexible drive means in which case the pulleys or sprockets are mounted on link or slide means fixed to the surroundings so as to allow radial motion of the pulleys or sprockets relative to the driven member, but not rotational motion due to the reaction torque on the driving means, and the two pulleys or sprockets are forced apart by a single tensioning means to produce equal and opposite forces on the driven means except for torque imposed by rotation of the driving means.

11. The drive in claim 1 in which a single driving means is used to provide torque through a gear box to two driven pulleys or sprockets, and the belt or chain is tensioned by moving the single motor and gear box in the radial direction.

12. The drive in claim 1 in which a single driving means is used to provide torque through a gear box to two driven pulleys or sprockets, which are used to provide balanced tension by rotation of the gear box around the input shaft of the single driving means, and the belt or chain is tensioned by moving the single motor and gear box in the radial direction.

13. The drive in claim 1 in which a single driving means is used to provide torque through a gear box to two driven pulleys or sprockets through means allowing limited relative rotation of the two pulleys or sprockets, and the belt or chain is tensioned by moving the single motor in the radial direction.

14. The drive in claim 1 in which the driven means is connected to the load via a clutch means which is chosen from the group: roller ramp clutch, cam clutch, ball clutch, electrically operated clutch, hydraulically operated clutch and mechanically operated clutch.

15. The drive in claim 1 in which the driving pulleys or sprockets are connected to the driving means by clutch means which are chosen from the group: roller ramp clutch, cam clutch, ball clutch, electrically operated clutch, hydraulically operated clutch and mechanically operated clutch.

16. The drive in claim 1 applied to rear wheel drive vehicles in which the drive is applied to the drive shaft allowing electric motors to drive the rear wheels of the vehicle in conjunction with the IC engine or by electric energy alone.

17. The drive in claim 1 applied to four-wheel drive vehicles in which the drive is applied to one of the drive shafts, allowing electric motors to provide power to drive the front and/or rear wheels of the vehicle in conjunction with the IC engine or by electric energy alone.

18. A conversion package or kit based on the foregoing claims comprising the parts necessary to provide a drive to convert a particular vehicle from an internal combustion vehicle to an IC-electric hybrid vehicle by the teachings of this invention, these parts comprising principally: an electric storage battery, a battery charger, a controller to control the power output of the electric motors, the electric motors and the drive means of this invention, along with necessary wiring, controls, instruments, fastenings and brackets, and an instruction manual detailing the individual steps in the conversion process, so that mechanics skilled in automotive repair can perform the conversion.

19. A conversion package in claim 17 in which the drive shaft or one of its components, with the drive means of this invention installed is supplied as a preconstructed, properly aligned and balanced unit.

20. A vehicle converted from an internal combustion vehicle to an IC-electric hybrid vehicle using the drive of claim 1, either as a new vehicle or a previously used vehicle, having the essential components of a flexible, force-balanced means to connect one or more electric motors to a drive shaft of the vehicle to provide a pure torque while allowing limited vibration and movement of the drive shaft relative to the vehicle chassis.
